(19) United States
(12) Patent Application Publication
(10) Pub. No.: US 2023/0370570 A1
(43) Pub. Date: Nov. 16, 2023

(54) DATA TRANSMISSION DEVICE, DATA TRANSMISSION METHOD, INFORMATION PROCESSING DEVICE, INFORMATION PROCESSING METHOD, AND PROGRAM

(71) Applicant: Sony Semiconductor Solutions Corporation, Kanagawa (JP)

(72) Inventors: Yoshimi OGAWA, Kanagawa (JP); Munehiro SHIMOMURA, Kanagawa (JP); Hideki ANDO, Kanagawa (JP); Yoshifumi MITSUI, Kanagawa (JP); Hironori MIYOSHI, Kanagawa (JP); Yoshihiro KUMAGAI, Kanagawa (JP); Kota YONEZAWA, Kanagawa (JP); Satoshi WATANABE, Kanagawa (JP); Hirotaka ISHIKAWA, Kanagawa (JP)

(73) Assignee: Sony Semiconductor Solutions Corporation, Kanagawa (JP)

(21) Appl. No.: 18/245,548

(22) PCT Filed: Jul. 20, 2021
(86) PCT No.: PCT/JP2021/027207

§ 371 Date: Mar. 16, 2023

(30) Foreign Application Priority Data
Sep. 18, 2020 (JP) 2020-157489

(51) Int. Cl. H04N 7/18

(52) U.S. Cl. CPC H04N 7/181

(57) ABSTRACT

A data transmission device includes a transmission processing unit that transmits sensing data of a detection target in response to occurrence of an event that satisfies a condition specified as an event related to the detection target, in which the sensing data is data including type information indicating a type of sensing data, in a case where whether or not the type of sensing data is a specific type is determined, and as a result, the type of sensing data is an unspecific type, the transmission processing unit performs processing of storing unspecific type information indicating that the type of sensing data is an unspecific type in the type information, and generating and transmitting the sensing data including text data in which detection result information indicating a detection result of the detection target by text and type information indicating a data type of the detection result information are stored.

### TECHNICAL FIELD

The present technology relates to a data transmission device, a data transmission method, an information processing device, an information processing method, and a program, and particularly relates to a technology for exchanging sensing data obtained by various sensors between devices.

### BACKGROUND ART

For example, it is conceivable to construct a monitoring system using a plurality of sensor devices, for example, it is conceivable to construct a monitoring system in which monitoring cameras are disposed at various places in town and monitoring is performed by using images.

However, in the related art, in this type of monitoring system, sensing data acquired by the sensor device such as a camera is assumed to be used only by an individual user who has installed the sensor device, and it has been difficult for other users to easily use the sensing data in a viewpoint of ensuring security or due to an interface which is not shared.

Therefore, as disclosed in Patent Document 1 below, the present applicant has previously proposed a system in which a framework is constructed in which various users can easily use information acquired from the sensing data acquired by various sensor devices.

Specifically, in Patent Document 1, sensor devices having different specifications and user devices having different specifications can be used in the framework by sharing an interface related to transfer of the sensing data. Furthermore, Patent Document 1 discloses that a load on data transfer is reduced not by constantly transmitting the sensing data from the sensor device to the user device but by transmitting only data when a condition requested from the user device side is satisfied to the user device side (for example, when a condition that a specific person appears in a monitoring image is satisfied, only data in which the person appears is transmitted).

### CITATION LIST

### Patent Document

Patent Document 1: WO 2020/100922 A

### SUMMARY OF THE INVENTION

### Problems to Be Solved by the Invention

Here, as in the system disclosed in patent Document 1, a standard called Network of Intelligent Camera Ecosystem (NICE) has been formulated in order to realize a system in which sensor devices having different specifications and user devices having different specifications can be used in a framework and only data when a predetermined condition is satisfied is transmitted to the user device side to reduce a load on data transfer.

As the NICE standard, NICE Data Pipeline Specification v1.0.1 (10.8.2. JSON Object) specifies a format of transmission data when the sensor device transmits sensing data (“SceneData”) when a predetermined condition is satisfied. Specifically, in this format, it is specified that “SceneData” as an actual data section in the sensing data and data called “SceneMark” which is an additional data section of “SceneData” and includes information of “SceneDataType” indicating a type of “SceneData” are transmitted.

In the current NICE standard, as the above-described “SceneDataType”, only limited specific types such as “RGBStill” (RGB still image), “RGBVideo” (RGB moving image), “ThermalStill” (temperature still image), “DepthVideo” (depth moving image), and “Humidity” (humidity) are specified as a specific format, and in a case of not belonging to these specific types, it is only specified that “other” is described as “SceneDataType”. That is, in a case where a sensor device that does not belong to the above-described specific types is used, since it is not specified that in which format data is generated as “SceneData”, a user terminal that receives “SceneData” cannot appropriately process “SceneData”. As a result, in a case where a sensor device of a type other than the specific type is used, an event that the sensing data cannot be used at all on the user terminal side occurs.

In order to enable the use of the sensing data obtained by a sensor of a type other than the specific type, for the type of sensor, it is considered to increase the number of specifications in the standard according to the output type of the sensor, but in that case, it takes time and effort to revise the standard every time a new type of sensor is added.

The present technology has been made in view of the above circumstances, and an object of the present technology is to make it possible to only present text information indicating a detection result of a sensor without adding a specification in a new standard for a type of the sensor even in a case where a sensor of a type other than the specific type not specifically assumed in terms of a standard is used in a sensing environment.

### Solutions to Problems

According to the present technology, there is provided a data transmission device including a transmission processing unit configured to perform processing of transmitting sensing data of a detection target in response to occurrence of an event that satisfies a condition specified as an event related to the detection target, in which the sensing data is data including type information indicating a type of sensing data, and in a case where whether or not the type of sensing data is a specific type is determined, and as a result, the type of sensing data is an unspecific type, the transmission processing unit performs processing of storing unspecific type information indicating that the type of sensing data is an unspecific type in the type information, and generating and transmitting the sensing data including text data in which detection result information indicating a detection result of the detection target by text and type information indicating a data type of the detection result information are stored.

According to this, in the device that receives the sensing data, even when the type of sensing data is an unspecific type, it is possible to acquire at least text information indicating the detection result and appropriately present text data indicating the detection result on the basis of the type information.

In the data transmission device according to the present technology described above, it is conceivable that the type information is information for identifying a numerical value and a character string.

According to this, in a case where the detection result information is numerical information, it is possible to correctly present the detection result information as the numerical information to the device that receives the sensing data by indicating that the detection result information is numerical information with the type information, and in a case where the detection result information is character string information, it is possible to correctly present the detection result information as the character string information to the device that receives the sensing data by indicating that the detection result information is character string information with the type information.

In the data transmission device according to the present technology described above, it is conceivable that the transmission processing unit performs processing of generating and transmitting text data including unit information indicating a unit of the detection result information as the sensing data in a case where the sensing data is of the unspecific type.

According to this, in a case where the detection result information is numerical information, the device that receives the sensing data can present information indicating the unit together with the detection result information with the numerical value.

In the data transmission device according to the present technology described above, it is conceivable that the transmission processing unit performs processing of generating and transmitting text data including information indicating a title of the detection result information as the sensing data in a case where the sensing data is of the unspecific type.

The information indicating a title of detection result information is information indicating an item name of the detection result information, and can be paraphrased as information indicating an information type of detection result information. With the above-described configuration, the device that receives the sensing data can present title information together with the detection result information.

In the data transmission device according to the present technology described above, it is conceivable that the transmission processing unit performs processing of generating and transmitting text data including information indicating the number of dimensions of the detection result information as the sensing data in a case where the sensing data is of the unspecific type.

According to this, in a case where the detection result information is information including detection information for each dimension, for example, information including detection information for the vertical direction and information including detection information for the horizontal direction, it is possible to cause the device that receives the sensing data to grasp the number of dimensions of the detection result information, and it is possible to present the detection information for each dimension in a distinguishing manner.

In the data transmission device according to the present technology described above, it is conceivable that the sensing data includes an additional data section including the type information and an actual data section including actual data indicating a detection result and in a case where the sensing data is of the unspecific type, the transmission processing unit generates the additional data section in which the unspecific type information is described as the type information, and generates text data in which the detection result information and the type information are described as data of the actual data section.

According to this, in a case where the type of sensing data is an unspecific type, the actual data section indicating the detection result can be made as lightweight data by using text data.

In the data transmission device according to the present technology described above, it is conceivable that the transmission processing unit generates the actual data section in a JSON format.

According to this, in a case where the sensing data is of an unspecific type, versatility of the actual data section including the detection result information can be increased.

According to the present technology, there is provided a data transmission method in a data transmission device configured to perform processing of transmitting sensing data of a detection target in response to occurrence of an event that satisfies a condition specified as an event related to the detection target, in which the sensing data is data including type information indicating a type of sensing data, and in a case where whether or not the type of sensing data is a specific type is determined, and as a result, the type of sensing data is an unspecific type, processing of storing unspecific type information indicating that the type of sensing data is an unspecific type in the type information, and generating and transmitting the sensing data including text data in which detection result information indicating a detection result of the detection target by text and type information indicating a data type of the detection result information are stored is performed.

In the data transmission method according to the present technology, it is also possible to obtain effects similar to those of the data transmission device according to the present technology described above.

Furthermore, according to the present technology, there is provided a first program causing a data transmission device to execute processing, the data transmission device performing processing of transmitting sensing data of a detection target in response to occurrence of an event that satisfies a condition specified as an event related to the detection target, the sensing data being data including type information indicating a type of sensing data, the program causing the data transmission device to execute a function of processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type.

In the first program, the data transmission device according to the present technology described above is realized.

Furthermore, according to the present technology, there is provided an information processing device including a transmission processing unit configured to perform processing of transmitting sensing data of a detection target in response to occurrence of an event that satisfies a condition specified as an event related to the detection target, in which the sensing data is data including type information indicating a type of sensing data, and the transmission processing unit includes an acquisition unit configured to acquire the sensing data transmitted by a data transmission device configured to perform processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type, and a presentation processing unit configured to determine whether or not the type information is the unspecific type information on the basis of the sensing data acquired by the acquisition unit and performs presentation processing of the detection result information on the basis of the type information in a case where the type information is the unspecific type information.

According to this, even when the type of sensing data is an unspecific type, text data indicating the detection result can be appropriately presented on the basis of the detection result information and the type information, which are described above.

According to the present technology, there is provided an information processing method in an information processing device including a transmission processing unit configured to perform processing of transmitting sensing data of a detection target in response to occurrence of an event that satisfies a condition specified as an event related to the detection target, in which the sensing data is data including type information indicating a type of sensing data, and the transmission processing unit acquires the sensing data transmitted by a data transmission device configured to perform processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type, the information processing method including determining whether or not the type information is the unspecific type information on the basis of the acquired sensing data and performing presentation processing of the detection result information on the basis of the type information in a case where the type information is the unspecific type information.

In the information processing method according to the present technology, it is also possible to obtain effects similar to those of the information processing device according to the present technology described above.

Furthermore, according to the present technology, there is provided a second program causing an information processing device to execute processing, the information processing device including a transmission processing unit configured to perform processing of transmitting sensing data of a detection target in response to occurrence of an event that satisfies a condition specified as an event related to the detection target, in which the sensing data is data including type information indicating a type of sensing data, and the transmission processing unit acquires the sensing data transmitted by a data transmission device configured to perform processing of storing unspecific type information indicating that the type of sensing data is an unspecific type in the type information and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type, the program causing the information processing device to execute a function of determining whether or not the type information is the unspecific type information on the basis of the acquired sensing data and performing presentation processing of the detection result information on the basis of the type information in a case where the type information is the unspecific type information.

In the second program, the information processing device according to the present technology described above is realized.

### BRIEF DESCRIPTION OF DRAWINGS

FIG. 1 is a block diagram illustrating a configuration example of a data distribution system according to an embodiment of the present technology.

FIG. 2 is a block diagram illustrating an internal configuration example of a sensor device according to the embodiment.

FIG. 3 is a block diagram illustrating a hardware configuration example of a computer device that implements a server device and a user device according to the embodiment.

FIG. 4 is a flowchart for explaining a flow of data distribution in a data distribution system according to the embodiment.

FIG. 5 is a diagram illustrating types of capture trigger information that can be specified in “SceneMode” of a NICE standard.

FIG. 6 is a diagram illustrating an example of a specific type defined in a standard for a type of sensing data.

FIG. 7 is an explanatory diagram of a method of generating/transmitting distribution data in a case where a type of sensing data to be transmitted is a specific type.

FIG. 8 is an explanatory diagram of a method of generating/transmitting distribution data in a case where a type of sensing data to be transmitted is an unspecific type.

FIG. 9 is a flowchart illustrating an example of a specific processing procedure to be executed to implement a method of generating/transmitting distribution data according to the embodiment.

FIG. 10 is a flowchart illustrating an example of processing after a user device receives distribution data.

FIG. 11 is a diagram illustrating an example of “SceneData” for detection result information other than Luminance.

FIG. 12 is a diagram illustrating a data example of “SceneMark” corresponding to a case where an external Schema is referred to.

FIG. 13 is an explanatory diagram of a case where the method described in FIG. 12 is applied to the example of FIG. 8.

FIG. 14 is an explanatory diagram of an example of directly embedding Schema in “SceneMark”.

FIG. 15 is a diagram illustrating a data example of “SceneMark” corresponding to a case where an external Schema is referred to with information of the standard type or the standard number.

### MODE FOR CARRYING OUT THE INVENTION

Hereinafter, an embodiment according to the present technology will be described in the following order with reference to the accompanying drawings.
<1. Overview of Data Distribution System according to Embodiment>
<2. Configuration Example of Sensor Device>
<3. Hardware Configuration Example of Server Device and User Device>
<4. Flow of Data Distribution>
<5. Regarding Method of Data Transmission and Method of Information Presentation according to Embodiment>
<6. Modification Example>
<7. Summary of Embodiment>
<8. Present Technology>

### 1. Overview of Data Distribution System According to Embodiment

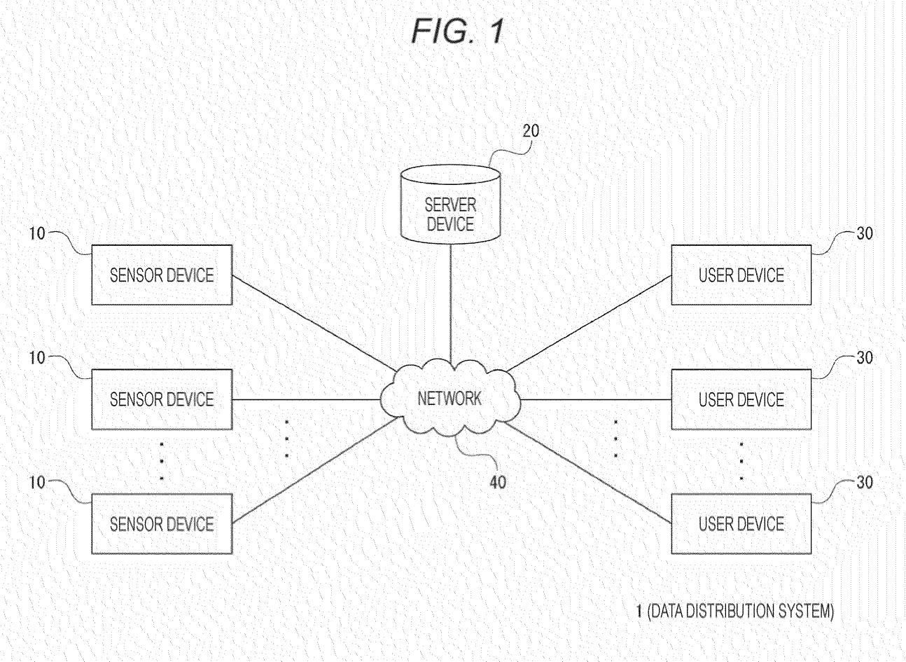

FIG. 1 is a block diagram illustrating a configuration example of a data distribution system 1 according to an embodiment of the present technology.

As illustrated in the drawing, the data distribution system 1 according to the embodiment includes a plurality of sensor devices 10, a server device 20, and a plurality of user devices 30. These devices can perform data communication with each other via a communication network represented as a network 40 in the drawing, such as the Internet, a home network, a local area network (LAN), or a satellite communication network.

Note that FIG. 1 illustrates an example in which four or more sensor devices 10 and four or more user devices 30 are provided, but the number of the sensor devices 10 and the number of the user devices 30 are not limited to four or more and only required to be one or more.

Each of the sensor devices 10 can acquire sensing data (for example, an image, a sound, and the like) of a surrounding environment in which each of the sensor devices 10 is installed), and transmit distribution data (predetermined data) acquired from the acquired sensing data to an external device such as each of the user devices 30. Furthermore, the sensor device 10 can recognize whether or not the acquired sensing data corresponds to a request (distribution request) from a user.

For example, it is considered that the sensor device 10 is an imaging device such as an imaging device (camera) mounted on a mobile object such as an automobile, an imaging device mounted on a smartphone carried by a user, or an imaging device such as a monitoring camera installed in a home, a store, or the like. In this case, the sensing data is an image. In this case, these imaging devices can condense light from a subject located around the imaging device to form an optical image on an imaging surface, and convert the optical image formed on the imaging surface into an electrical image signal to acquire an image. Note that in the following description, unless otherwise specified, the mobile object may be an automobile, a motorcycle, a bicycle, a personal mobility, an airplane, a drone, a ship, a robot (mobile robot), a construction machine, an agricultural machine (tractor), or the like.

The sensor device 10 is not limited to the imaging device described above. In the present embodiment, for example, it is conceivable that an example of the sensor device 10 includes various sensors such as a depth sensor (distance measurement sensor) that measures a distance (depth) to a subject, a sound collection device such as a microphone that collects sound of a surrounding environment, a temperature sensor and a humidity sensor which measure temperature and humidity of the surrounding environment, and a water level sensor that measures a water level of a river or the like.

Note that, in the present embodiment, an internal configuration of the sensor device 10 is not basically limited as long as the sensor device 10 has an interface (data transfer format, data transfer method, and the like) common to the data distribution system 1. Therefore, the data distribution system 1 according to the present embodiment can includes various sensor devices 10 having different specifications. Note that the internal configuration example of the sensor device 10 will be described later.

The server device 20 is a computer device that receives a distribution request of requesting, by the user device 30, distribution of distribution data generated from the sensing data. In the present example, the server device 20 can also receive distribution data from the sensor device 10 and transmit the received distribution data to the user device 30 that is a transmission source of the distribution request described above as necessary.

For example, the server device 20 can be implemented by hardware such as a central processing unit (CPU), a read only memory (ROM), and a random access memory (RAM). Note that a hardware configuration example of the server device 20 will be described later.

The user device 30 is a terminal device that is carried by the user or installed near the user, can receive information input from the user, can transmit the received information to the server device 20 as a distribution request, and can receive the distribution data corresponding to the distribution request. For example, the user device 30 may be configured as a mobile terminal such as a tablet personal computer (PC), a smartphone, a mobile phone, a laptop PC, or a notebook PC, or a wearable device such as a head mounted display (HMD). More specifically, the user device 30 can include a display unit that performs display for the user, an input unit that receives an input operation from the user, a sound output unit that performs sound output for the user.

Note that a hardware configuration example of the user device 30 will be described later.

In the user device 30, for example, an application common to the data distribution system 1 or an application having a specification common to the server device 20 described above can be installed. By installing such an application, the user device 30 can generate and transmit a distribution request having a format or the like common to the data distribution system 1, and can receive the distribution data.

Here, in the present embodiment, the user is assumed to be not only an individual but also the following person. For example, the user can be a map manufacturer, a store opening strategy planner, a road management authority, a person in charge of social infrastructure development, or the like. More specifically, when using the service provided in the present embodiment, the map manufacturer can create a detailed map without manpower, and the store opening strategy planner can easily collect information when considering a store opening. Furthermore, when using the service described above, the road management authority can easily collect information for making a road repair plan based on estimation of a road condition, a travelling vehicle type, and the like. Moreover, when using the service described above, the person in charge of social infrastructure development planning can consider application to preventive measures and telematics insurance by performing statistics and analysis for driving tendencies and accident causes.

Furthermore, in the data distribution system 1, the user can transmit the distribution request to the server device 20 via the user device 30. The distribution request includes information specifying a content (data type) of data which the user requests distribution of.

In the data distribution system 1 of the present embodiment, the sensing data obtained by the sensor device 10 is not continuously transmitted to the user device 30 at all times, and only the sensing data obtained when a predetermined condition is satisfied is transmitted to the user device 30 side. Therefore, the load on the data transfer is reduced.

The predetermined condition described here is a condition regarding an event related to a target to be detected by the sensor device 10. For example, in a case where the sensing data is an image captured by a camera, it is conceivable to set, as the condition, occurrence of an event in which a person appears, a face of a person is recognized, or an animal appears, for example.

In the present example, when a predetermined condition defined for such a detection target is satisfied, the sensor device 10 captures a data when the predetermined condition is satisfied from the sensing data, and transmits the captured data to the user device 30 as distribution data.

At this time, the predetermined condition described above can be specified as information of a “capture trigger” in the distribution request described above.

In the present embodiment, in the data distribution system 1 configured as described above, in order to construct a framework in which various users can easily use information obtained from sensing data acquired by various types of sensor devices 10, a standard called Network of Intelligent Camera Ecosystem (NICE) specifying a format of the above-described distribution request, data distributed by the sensor devices 10, and the like is adopted.

In the NICE standard, the type of information that can be specified as the “capture trigger” in the distribution request described above and the type of sensing data to be distributed as the distribution data are defined, and specific data formats of the information of the “capture trigger” and the distribution data are defined. Note that this point will be described again later.

### 2. Configuration Example of Sensor Device

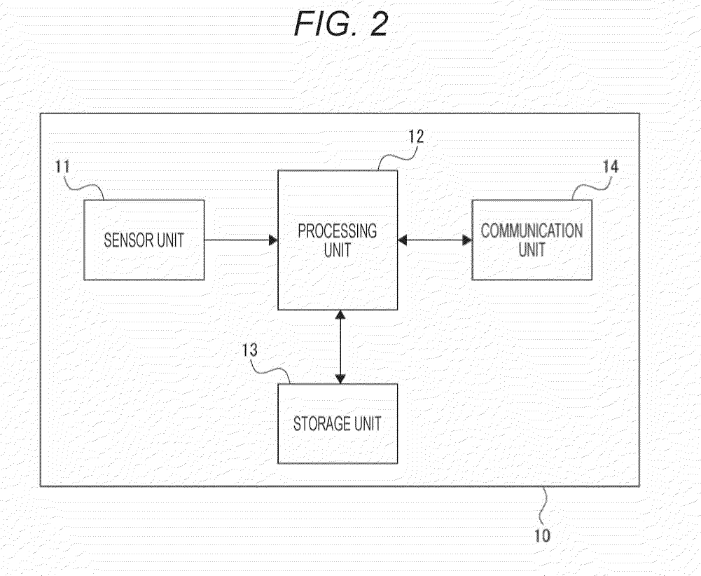

FIG. 2 is a block diagram illustrating the internal configuration example of the sensor device 10.

The sensor device 10 includes a sensor unit 11, a processing unit 12, a storage unit 13, and a communication unit 14.

The sensor unit 11 acquires sensing data and outputs the acquired sensing data to the processing unit 12.

For example, in a case where the sensor device 10 is an imaging device, the sensor unit 11 includes an imaging optical system such as an imaging lens that condenses light emitted from a subject and a zoom lens, and an imaging element such as a charge coupled device (CCD) image sensor or a complementary metal oxide semiconductor (CMOS) image sensor.

Furthermore, the sensor unit 11 may be configured to have a subject recognition function. For example, in a case of a function of recognizing the type of the imaged object as the subject recognition function, the sensor unit 11 may output information indicating a recognition result as sensing data. For example, it is conceivable to output text data indicating the type of recognized object as sensing data.

Alternatively, as the subject recognition function, it is conceivable to have a function of counting the number of designated objects or a function of counting the number of people in a specific state (for example, the number of people who are talking, and the like). In this case, it is conceivable to output text data indicating the number of objects or the number of people as sensing data.

Moreover, an example of the sensor unit 11 may include a time of flight (ToF) sensor (not illustrated) as a depth sensor (distance measurement sensor) in addition to the imaging device. The ToF sensor can acquire shape information (depth information/image) such as a distance and unevenness between the ToF sensor and the subject by directly or indirectly measuring a return time of light reflected from the subject.

Furthermore, examples of the sensor unit 11 may include a positioning sensor such as an infrared (IR) camera or a global navigation satellite system (GNSS) sensor, a temperature sensor, a sound collection device (microphone), an atmospheric pressure sensor, a humidity sensor, a wind direction/wind speed sensor, a sunshine sensor, a precipitation sensor, a water level sensor, and a seismic intensity sensor (sensor that detects seismic intensity of an earthquake), and the sensor unit 11 is not particularly limited as long as sensing data can be acquired from the surrounding environment (sensing environment).

Note that the sensor unit 11 may be provided so as to be fixed in the sensor device 10, or may be provided to be attachable to or detachably from the sensor device 10.

The processing unit 12 includes, for example, a processing circuit such as a CPU and a graphics processing unit (GPU), and a microcomputer including a ROM, and a RAM, and performs overall control of the sensor device 10, for example, by executing processing based on a program stored in a storage device such as the ROM. In particular, the processing unit 12 of the present embodiment has a function of processing sensing data acquired by the sensor unit 11 and generating distribution data.

Note that a specific generation method of the distribution data in the present embodiment will be described later.

The storage unit 13 stores programs, information, and the like for the processing unit 12 to execute various processing, and information obtained by the processing. For example, the storage unit 13 can be used for temporary storage of sensing data output from the sensor unit 11. Note that the storage unit 13 is realized by, for example, the storage device such as a solid state drive (SSD) or a hard disk drive (HDD).

The communication unit 14 can transmit and receive data to and from an external device such as the server device 20 or the user device 30. In other words, the communication unit 14 can be said to be a communication interface having a function of transmitting and receiving data.

### 3. Hardware Configuration Example of Server Device and User Device

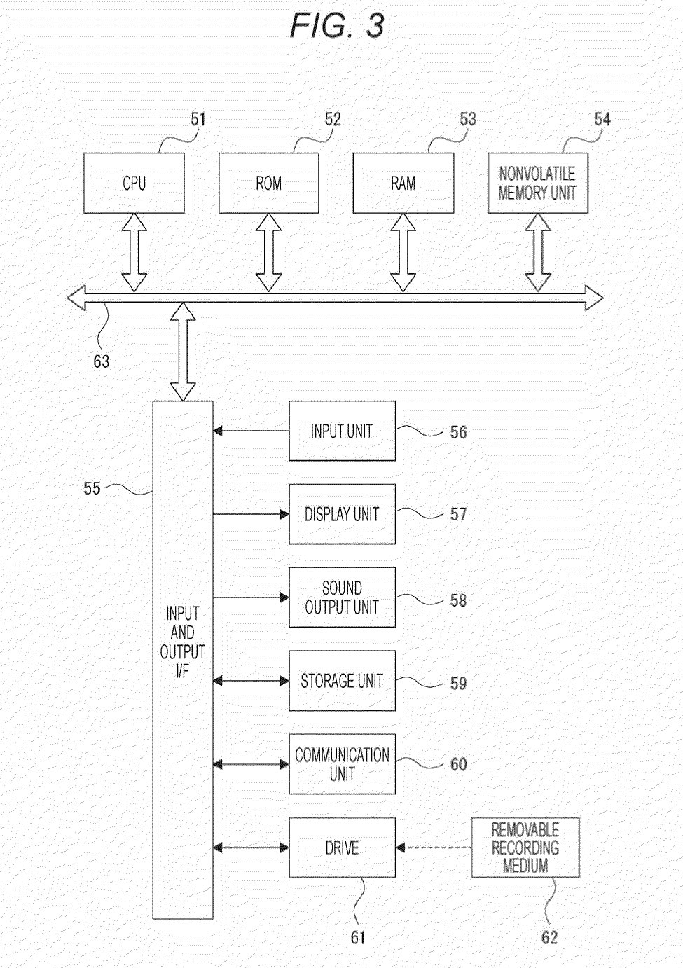

FIG. 3 is a block diagram illustrating a hardware configuration example of the computer device that implements the server device 20 and the user device 30 which are illustrated in FIG. 1.

A CPU 51 of the computer device executes various processing in accordance with a program stored in a nonvolatile memory unit 54 such as a ROM 52 or an electrically erasable programmable read-only memory (EEP-ROM), or a program loaded from a storage unit 59 to a RAM 53. The RAM 53 also appropriately stores data and the like necessary for the CPU 51 to execute various processing.

The CPU 51, the ROM 52, the RAM 53, and the nonvolatile memory unit 54 are connected to each other via a bus 63. An input and output interface 55 is connected to the bus 63 as well.

An input unit 56 including an operator and an operation device is connected to the input and output interface 55. For example, as the input unit 56, various operators and operation devices such as a keyboard, a mouse, a key, a dial, a touch panel, a touch pad, and a remote controller are assumed.

The operation of the user by the input unit 56 is detected, and a signal corresponding to the input operation is transmitted by the CPU 51.

Furthermore, a display unit 57 including a liquid crystal display (LCD), and an organic electroluminescence (EL) panel, and a sound output unit 58 including a speaker are integrally or separately connected to the input and output interface 55.

The display unit 57 is a display unit that performs various displays, and includes, for example, a display device provided in a casing of the server device 20 or the user device 30, a separate display device connected to the server device 20 or the user device 30.

The display unit 57 executes display of an image for various image processing, a moving image to be processed, and the like on a display screen on the basis of an instruction from the CPU 51. Furthermore, the display unit 57 performs display of various operation menus, icons, messages, and the like, that is, display as a graphical user interface (GUI), on the basis of the instruction of the CPU 51.

In some cases, the storage unit 59 including a solid-state memory such as an HDD or an SSD or a communication unit 60 including a modem or the like is connected to the input and output interface 55.

The communication unit 60 performs communication processing via a transmission path such as the Internet, wired/wireless communication with various devices, and communication via a bus.

Furthermore, a drive 61 is connected to the input and output interface 55 as necessary, and a removable recording medium 62 such as a magnetic disk, an optical disk, a magneto-optical disk, or a semiconductor memory is appropriately mounted to the input and output interface 55.

The drive 61 can read a data file such as an image file, various computer programs, and the like from the removable recording medium 62. The read data file is stored in the storage unit 59, and images and sounds included in the data file are output by the display unit 57 and the sound output unit 58. Furthermore, the computer programs, and the like read from the removable recording medium 62 are installed in the storage unit 59 as necessary.

In such a computer device, for example, software for the processing of the present embodiment can be installed by network communication of the communication unit 60 or via the removable recording medium 62. Alternatively, the software may be stored in advance in the ROM 52, the storage unit 59, or the like.

### 4. Flow of Data Distribution

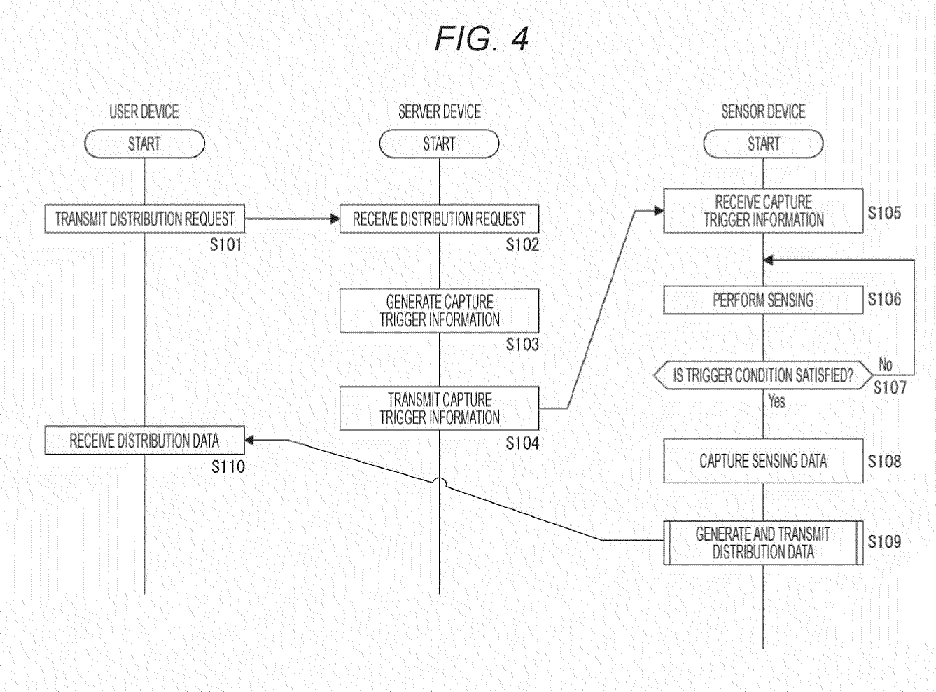

FIG. 4 is a flowchart for explaining a flow of the data distribution.

Note that, in FIG. 4, processing indicated for “user device” is processing executed by the CPU 51 in the computer device as the user device 30, and processing indicated for “server device” is processing executed by the CPU 51 of the computer device as the server device 20. Processing indicated for “sensor device” is processing executed by the processing unit 12 in the sensor device 10.

In FIG. 4, the user device 30 performs transmission processing of the distribution request in step S101. That is, information input from the user is received, and the received information as a distribution request is transmitted to the server device 20.

In step S102, the server device 20 receives the distribution request from the user device 30. Then, the server device 20 generates capture trigger information in step S103 on the basis of the distribution request received in step S102. As understood from the above description, the capture trigger information is information indicating the predetermined condition when data when the predetermined condition is satisfied from the sensing data is captured according to the satisfaction of the predetermined condition specified for the detection target. As described above, regarding the capture trigger information, the type of information that can be specified is defined in the NICE standard. Specifically, the type of capture trigger information is defined in “SceneMode” of the NICE standard.

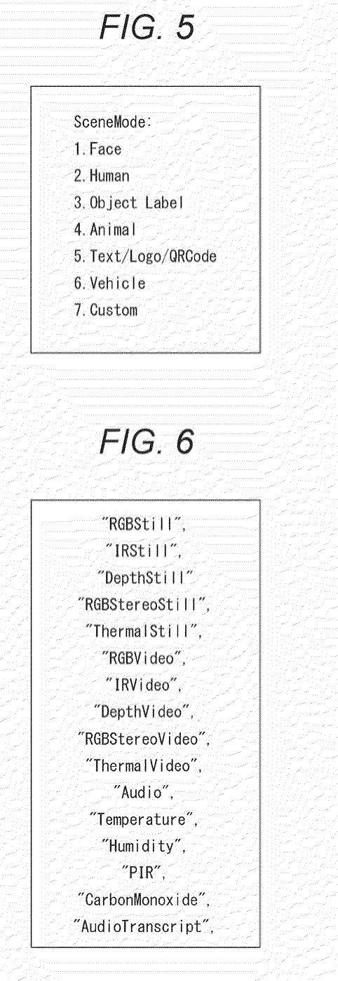

FIG. 5 illustrates types of capture trigger information that can be specified in “SceneMode”.

As illustrated in the drawing, “Face”, “Human”, “Object Label”, “Animal”, “Text/Logo/QRcode”, “Vehicle”, and “Custom” can be specified as the capture trigger information.

For example, when “Face” is specified, detection of the face of a person can be specified as a capture trigger, and when “Animal” is specified, detection of an animal can be specified as a capture trigger.

In FIG. 4, the server device 20 generates such capture trigger information in step S103, and transmits the generated capture trigger information to the sensor device 10 in subsequent step S104.

The sensor device 10 receives the capture trigger information from the server device 20 in step S105. Then, as the sensing processing in step S106, the sensor device 10 performs processing of causing the sensor unit 11 to execute sensing, and acquires sensing data.

Moreover, in step S107, the sensor device 10 determines whether or not a trigger condition is satisfied. That is, it is determined whether or not the condition (trigger condition) specified as the capture trigger information is satisfied. For example, in the example of “Face” described above, the sensor unit 11 performs image recognition, and thus processing of determining whether or not a face of a person is recognized in the captured image is performed.

In a case where it is determined that the trigger condition is not satisfied in step S107, the sensor device 10 returns the processing to step S106. Accordingly, the sensing processing can be performed until the trigger condition is satisfied.

On the other hand, in a case where it is determined that the trigger condition is satisfied in step S107, the sensor device 10 performs processing of capturing sensing data in step S108. That is, among pieces of the sensing data obtained by the sensor unit 11, some data when a predetermined condition specified as the trigger condition is satisfied are captured. For example, in a case where the sensing data is image data and the trigger condition is “Face”, one frame of image data (still image data) when the face of the person is recognized is captured.

In step S109 subsequent to step S108, the sensor device 10 performs processing of generating/transmitting the distribution data, and transmits the distribution data including the captured sensing data to the user device 30.

Note that specific processing contents of step S109 will be described later again.

The user device 30 receives the distribution data transmitted by the sensor device 10 in step S110.

Note that in the present example, since the distribution data is directly transmitted from the sensor device 10 to the user device 30, a processing load on the server device 20 can be reduced, and an operation cost of the server device 20 can be reduced.

However, the configuration is not limited in which the sensor device 10 directly transmits the distribution data to the user device 30. A configuration in which the distribution data is transmitted from the sensor device 10 to the user device 30 via the server device 20 can be provided. In this case, even when the user device 30 does not have an interface common to the data distribution system 1, the user device 30 can receive the distribution data as long as the user device 30 has the interface common to the server device 20.

### 5. Regarding Method of Data Transmission and Method of Information Presentation According to Embodiment

Here, as the NICE standard, NICE Data Pipeline Specification v1.0.1 (10.8.2. JSON Object) specifies a format of data distributed by the sensor device 10. Specifically, in this format, it is specified that “SceneData” as an actual data section in the sensing data and data called “SceneMark” which is an additional data section of “SceneData” and includes information of “SceneDataType” indicating a type of “SceneData” are transmitted.

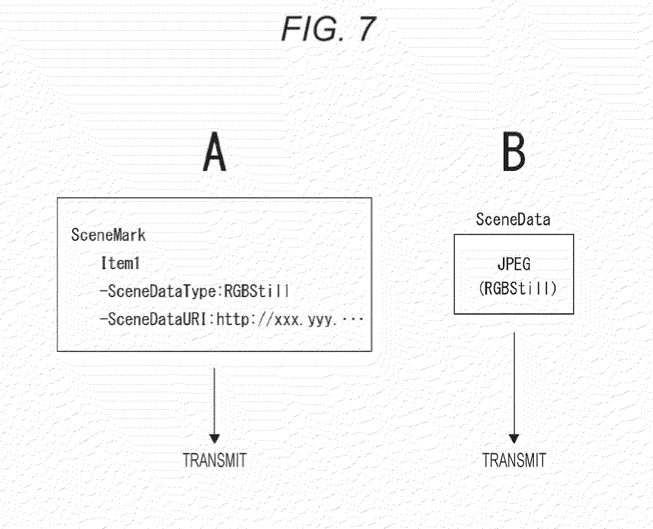

In the current NICE standard, information of each type listed in FIG. 6 is defined as “SceneDataType” described above. Examples thereof include “RGBStill” (RGB still image), “RGBVideo” (RGB moving image), “ThermalStill” (temperature still image), “DepthVideo” (depth moving image), and “Humidity” (humidity).

In the current NICE standard, only limited specific types illustrated in FIG. 6 are specified as a specific format, and in a case of not belonging to these specific types, it is only specified that “other” is described as “SceneDataType”. That is, in a case where a sensor device that does not belong to the above-described specific types is used, since it is not specified that which format data is generated as “SceneData”, the user device 30 that receives “SceneData” included in the distribution data cannot appropriately process “SceneData”. As a result, in a case where a sensor device 10 of a type other than the specific type is used, an event that the sensing data cannot be used at all on the user device 30 side occurs.

Therefore, in the present embodiment, the following method is adopted as a countermeasure for a case where the type of sensing data to be transmitted is an unspecific type other than the specific type illustrated in FIG. 6.

First, as a comparison, a method of generating/transmitting the distribution data in a case where the type of sensing data to be transmitted is any specific type illustrated in FIG. 6 will be described.

FIG. 7 is an explanatory diagram of a method of generating/transmitting the distribution data in a case where the type of sensing data to be transmitted is “RGBStill”.

As described above, for the distribution data, it is specified that “SceneData” (FIG. 7A) as an actual data section in the sensing data and data called “SceneMark” (FIG. 7B) which is an additional data section of “SceneData” and includes information of “SceneDataType” indicating a type of “SceneData” are transmitted.

In a case where “SceneDataType” is “RGBStill”, as illustrated in the drawing, for example, data (binary data) of joint photographic experts group (JPEG) is transmitted as “SceneData”. For “SceneMark”, data describing information of “SceneDataType” and “SceneDataURI” is transmitted as illustrated in the drawing.

Here, “SceneDataURI” is information of a uniform resource identifier (URI) indicating a recording destination address of “SceneData”. In the present example, the user device 30 transmits, to the server device 20, information including specified information of a recording destination address of “SceneData” as information of the distribution request described above, and the server device 20 transmits the specified information of the recording destination address to the sensor device 10 together with the capture trigger information described above. The sensor device 10 performs processing of transmitting “SceneData” such that “SceneData” is recorded in the recording destination address specified in the distribution request by the user device 30. Then, the sensor device 10 describes information of URI indicating the recording destination address in “SceneDataURI” of “SceneMark”.

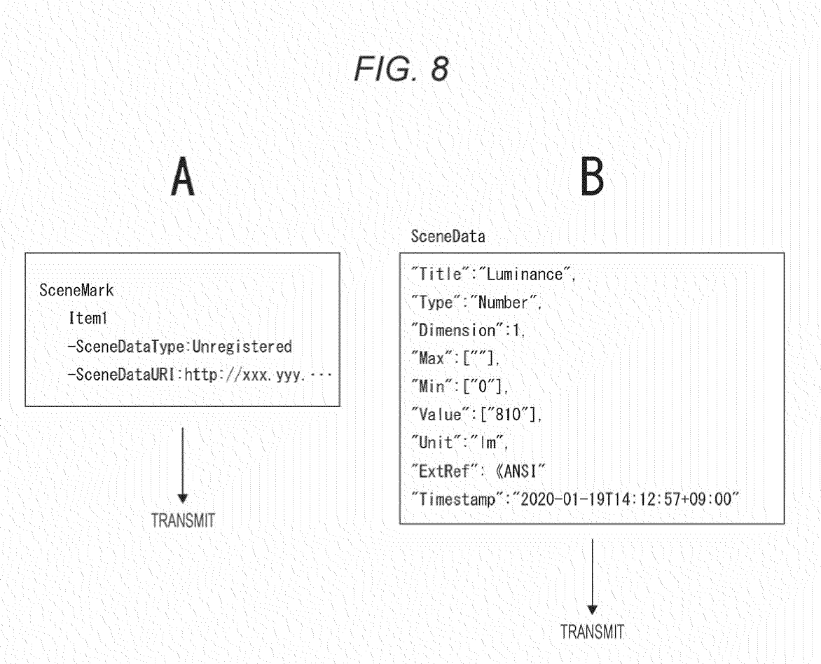

FIG. 8 is an explanatory diagram of a method of generating/transmitting the distribution data in a case where the type of sensing data to be transmitted is an unspecific type other than the specific type illustrated in FIG. 6.

In the present embodiment, in a case where the type of sensing data to be transmitted is an unspecific type, “SceneDataType” in “SceneMark” illustrated in FIG. 8A stores the unspecific type information indicating that the type is the unspecific type. As the unspecific type information, information other than “other” in the related art is described. Specifically, in the present example, “Unregisterd” is stored.

Then, for “SceneData”, as illustrated in FIG. 8B, pieces of text data describing information of items of “Title”, “Type”, “Dimension”, “Max”, “Min”, “Value”, “Unit”, “ExtRef”, and “Timestamp” are generated.

Here, among these items, “Value” is information indicating a detection result of the sensor unit 11 (hereinafter, referred to as “detection result information”), and “Title”, “Type”, and “Unit” are information indicating a title, information indicating a data type, and unit information, respectively, for the detection result information. For the item “Title”, the “information indicating a title” mentioned here is information indicating an item name of the detection result information, and can be paraphrased as information indicating an information type of detection result information (information indicating what the detection result is for).

Furthermore, specifically, the data type as “Type” describes information for identifying a numerical value and a character string, and describes either “number” or “string” in the present example.

FIG. 8B illustrates an example in a case where the detection result information is information of Luminance. In this case, for example, “Title” describes “Luminance”, “Type” describes “Number” (since the detection result of “Luminance” is numerical information), “Value” describes a detection value (here, “810”), and “Unit” describes “1m” (lumen), which is a unit of luminance.

Furthermore, in FIG. 8B, “Max” and “Min” describe the maximum value and the minimum value, respectively, for the detection value, and “Timestamp” describes, as time information (including information regarding year/month/day), for example, time information corresponding to a time point at which an event as a capture trigger occurs.

Furthermore, “Dimension” represents the number of dimensions of “Value”. For example, in a case where “Value” is acceleration or the like and is detected in a vertical direction and a horizontal direction, the number of dimensions is “two”, and thus “two” is described in “Dimension”. Alternatively, in a case where “Value” is, for example, a luminance value or the like and is detected for each color of R, G, and B, the number of dimensions is “three”, and “three” is described in “Dimension”.

At this time, square brackets ([]) are adopted in the respective items of “Value”, “Max”, and “Min”, and a plurality of numerical values can be described in the square brackets. For example, for “Value”, in a case where the detection values of R, G, and B are “810”, “560”, and “600”, respectively, it can be described as [“810”, “560”, “600”].

The item of “ExtRef” is an item of reference information regarding a data structure definition (Schema) of “SceneData” by the text data. Note that the item of “ExtRef” is optional.

For confirmation, Schema means a language that defines a document structure (logical document structure) of a data description language such as a HyperText Markup Language (HTML) or an Extensible Markup Language (XML).

Here, “SceneData” illustrated in FIG. 8B can be rephrased as text data in which detection result information (information of “Value”) indicating a detection result of a detection target by text and type information (information of “Type”) indicating a data type of the detection result information are stored.

As can be seen with reference to FIG. 8B, in the present example, data in a JavaScript Object Notation (JSON) format is generated as text-based “SceneData” in a case where the type of sensing data to be transmitted is an unspecific type. Therefore, the versatility of “SceneData” can be increased.

Specifically, a PC, a smartphone, or the like is assumed as the user device 30 that receives the distribution data, but since such a user device 30 generally has a function of interpreting data described in the JSON format, “SceneData” as illustrated in FIG. 8B can be interpreted by almost all the user devices 30. In this sense, the versatility of “SceneData” is increased.

As described above, in the present embodiment, in a case where whether or not the type of sensing data to be transmitted is a specific type is determined and as a result, the type of sensing data is an unspecific type, the sensor device 10 performs processing of storing unspecific type information (in the present example, “Unregisterd”) indicating that the type of sensing data is an unspecific type in “SceneDataType” of “SceneMark”, and generating and transmitting sensing data including text data in which and detection result information (“Value”) indicating the detection result obtained by the sensor unit 11 by text and type information (“Type”) indicating the data type of the detection result information are stored.

Accordingly, in the device (the user device 30 in the present example) receiving the sensing data, even when the type of sensing data is an unspecific type, it is possible to acquire at least text information indicating the detection result and appropriately present text data indicating the detection result on the basis of the type information.

Therefore, it is possible to only present text information indicating the detection result of the sensor without adding a specification in a new standard for the type of sensor even in a case where a sensor of an unspecific type not specifically assumed in terms of a standard is used in the sensing environment.

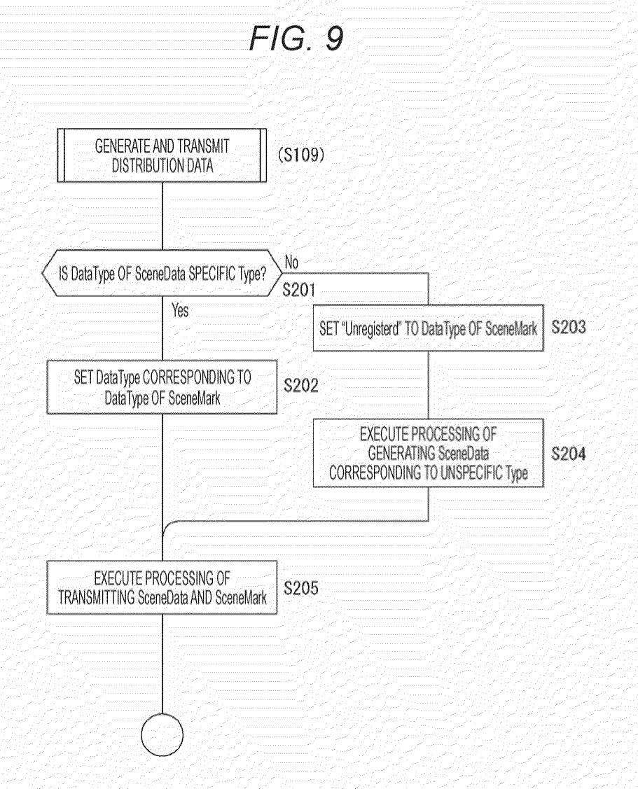

FIG. 9 is a flowchart illustrating an example of a specific processing procedure to be executed to implement a method of generating/transmitting distribution data according to the embodiment described above, and specifically, illustrates processing to be executed as “processing of generating/transmitting distribution data” in step S109 illustrated in FIG. 4.

Note that the processing illustrated in FIG. 9 is executed by the processing unit 12 of the sensor device 10 on the basis of a program stored in a storage device such as a ROM.

First, in step S201, the processing unit 12 determines whether or not a data type of “SceneData” is a specific type. That is, it is determined whether or not a data type of the sensing data (that is, the sensing data to be transmitted) captured in step S108 of FIG. 4 coincides with any type illustrated in FIG. 6.

When the data type of “SceneData” is a specific type, the processing unit 12 causes the processing to proceed to step S202, sets a data type corresponding to a data type of “SceneMark”, and causes the processing to proceed to step S205. That is, information indicating a data type determined to coincide in step S201 is stored in the item of “SceneDataType” in “SceneMark”, and the processing proceeds to step S205.

On the other hand, in step S201, when the data type of “SceneData” is not the specific Type, the processing unit 12 causes the processing to proceed to step S203 and sets “Unregisterd” to a data type of “SceneMark”. That is, “Unregisterd” is stored in the item of “SceneDataType” of “SceneMark”.

Then, in subsequent step S204, the processing unit 12 generates “SceneData” corresponding to an unspecific type. That is, in the present example, as illustrated in FIG. 8B, text data including items of “Title”, “Type”, “Dimension”, “Max”, “Min”, “Value”, “Unit”, “ExtRef”, and “Timestamp” are generated as “SceneData”.

When the generation processing in step S204 is executed, the processing unit 12 causes the processing to proceed to step S205.

In step S205, the processing unit 12 executes processing of transmitting “SceneData” and “SceneMark”. Note that in step S205, as the transmission processing of SceneData in a case where a data type is a specific type, sensing data is transmitted in a data format specified for the specific type, for example, transmission of JPEG data in a case of “RGBStill” (see FIG. 7A).

The processing unit 12 ends the “processing of generating/transmitting distribution data” in step S109 when the processing in step S205 has been executed.

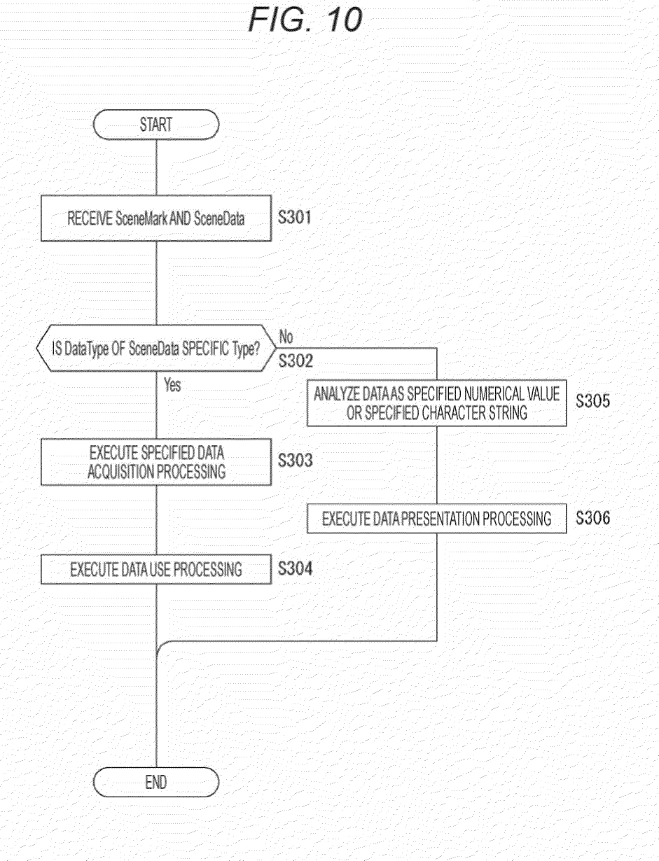

FIG. 10 is a flowchart illustrating an example of processing after the user device 30 receives the distribution data. Note that the processing illustrated in FIG. 10 is executed by the CPU 51 (see FIG. 3) of the computer device as the user device 30, for example, on the basis of a program stored in the storage device such as the storage unit 59.

First, in step S301, the user device 30 performs reception processing of “SceneMark” and “SceneData”.

Then, in subsequent step S302, the user device 30 determines whether or not a data type of “SceneData” is a specific type. That is, it is determined whether or not a data type indicated by “SceneDataType” in the received “SceneMark” coincides with any type illustrated in FIG. 6.

When the data type of “SceneData” is a specific type, the user device 30 causes the processing to proceed to step S303 and executes specified data acquisition processing. For example, when a data type is “RGBStill”, data acquisition processing specified for a data type in the standard is executed, for example, decoding processing is performed for JPEG data.

Then, the user device 30 executes data use processing in subsequent step S304, and ends the processing of the example illustrated in FIG. 10. Here, the data use processing in step S304 broadly means processing of using the data acquired in step S303, and is not limited to the specific processing.

Furthermore, in step S302, when the data type of “SceneData” is not a specific type, the user device 30 causes the processing to proceed to step S305 and performs processing of analyzing the data as a specified numerical value or character string. That is, processing of analyzing the received “SceneData” (see FIG. 8B) as a numerical value (“number”) or a character string (string) specified by the information of “Type” (data type) of “SceneData” is performed.

Then, in step S306 subsequent to step S305, the user device 30 performs processing of presenting the analyzed data to the user as data presentation processing. The presentation here means visual presentation or auditory presentation. Alternatively, it may include tactile presentation.

Specifically, in step S306, the user device 30 performs processing of displaying at least the information of “Value” included in the received “SceneData” on the display unit 57. For example, in the example of FIG. 8B, the processing of displaying the numerical information of “810” is performed. Alternatively, the numerical information may be presented to the user in a form of sound output performed by the sound output unit 58.

Here, the presentation information in step S306 can include, for example, all or some of “Unit”, “Title”, “Max”, “Min”, and “Timestamp” in addition to “Value”.

The user device 30 ends the series of processing illustrated in FIG. 10 when the presentation processing in step S306 is executed.

### 6. Modification Example

Note that the embodiment is not limited to the specific examples described above, and various configurations as a modification example can be adopted.

For example, in the above description, the data example corresponding to the case where the detection result information is Luminance has been described as an example of “SceneData” in the case where the type of sensing data to be transmitted is an unspecific type. However, this is merely an example, and various types of correspondable detection result information can be considered.

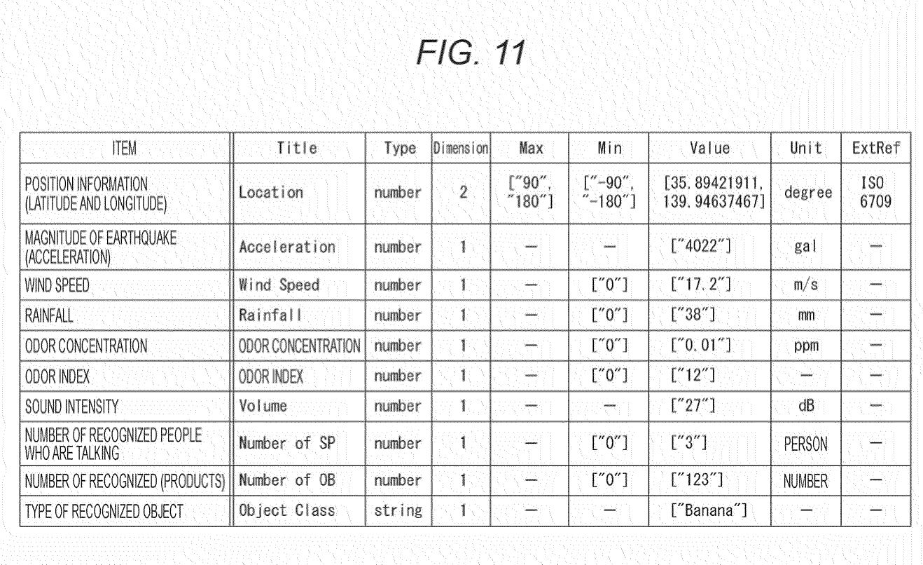

FIG. 11 is a diagram illustrating an example of “SceneData” for detection result information other than Luminance.

Here, examples of the detection result information include “position information (latitude and longitude)”, “magnitude of earthquake (acceleration)”, “wind speed”, “rainfall”, “odor concentration”, “odor index”, “sound intensity”, “number of recognized people who are talking”, “number of recognized (products)”, and “type of recognized object”, and description examples of “Title”, “Type”, “Dimension”, “Max”, “Min”, “Value”, “Unit”, and “ExtRef” are illustrated for each of these pieces of the detection result information. Note that “TimeStamp” is not illustrated.

For example, for “position information (latitude and longitude)”, as “ExtRef”, “ISO 6709” is referred to in consideration of the fact that there is an international standard.

Furthermore, as described above, there is a case where recognition result information for the subject is output as the detection result information obtained by the sensor unit 11, and “number of recognized people who are talking”, “number of recognized (products)”, and “type of recognized object” correspond to the examples. For “number of recognized people who are talking” and “number of recognized (products)”, “Type” is “number”. For “type of recognized object”, it is assumed that character string information indicating the type of object is output as the detection result information, and “Type” is “string”.

Note that, in the example of FIG. 11, in particular, a description content of the item “Title” is merely an example, and it goes without saying that the description content is not limited to this.

Furthermore, in the above description, for “SceneData” in a case where the type of sensing data to be transmitted is an unspecific type, “number” and “string” have been described as examples of the type information described in “Type”. However, in a case where the detection result information is numerical information, information for identifying “integer” or “boolean” (truth value) can be described as the information of “Type”.

Furthermore, in the above description, an example has been described in which in a case where the type of sensing data to be transmitted is an unspecific type, “SceneData” is generated and transmitted separately from “SceneMark”. However, as will described below, a method of storing “Type”, “Schema”, and “Data” in “SceneMark” and transmitting these can also be adopted.

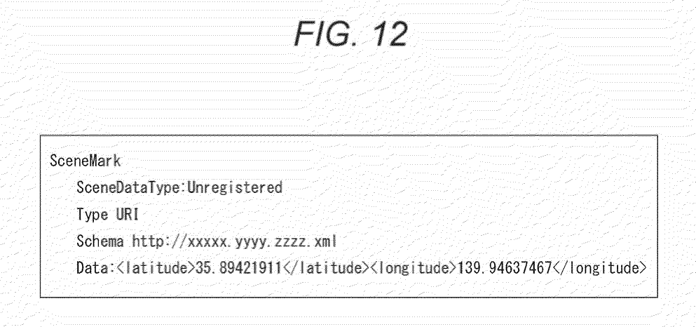

FIG. 12 is a diagram illustrating a data example of “SceneMark” corresponding to a case where an external Schema is referred to. Here, a case where the detection result information obtained by the sensor unit 11 is position information (latitude and longitude) will be provided an example.

As illustrated in the drawing, in “SceneMark” in this case, items of “Type”, “Schema”, and “Data” are provided together with “SceneDataType” (: Unregistered), “URI” is described in “Type”, and information of URI in which Schema is disclosed is described in “Schema”. As illustrated in the drawing, information of latitude and longitude is described in “Data”. Note that, here, “SceneMark” is described in an extensible markup language (XML) format as an example.

In this case, Schema disclosed in URI described in the item of “Schema” is “<latitude>number</latitude><longitude>number<longitude>” .

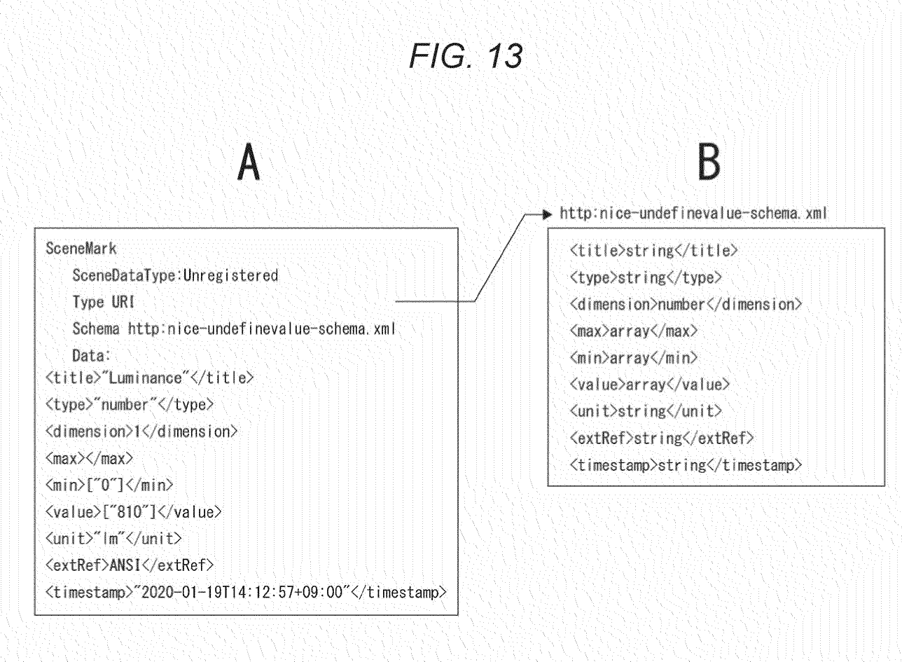

FIG. 13 is an explanatory diagram illustrating a case where the method described in FIG. 12 is applied to an example of FIG. 8, FIG. 13A illustrates an example of data of “SceneMark”, and FIG. 13B illustrates an example of Schema referred to in URI described in “Schema” of “SceneMark” illustrated in FIG. 13A.

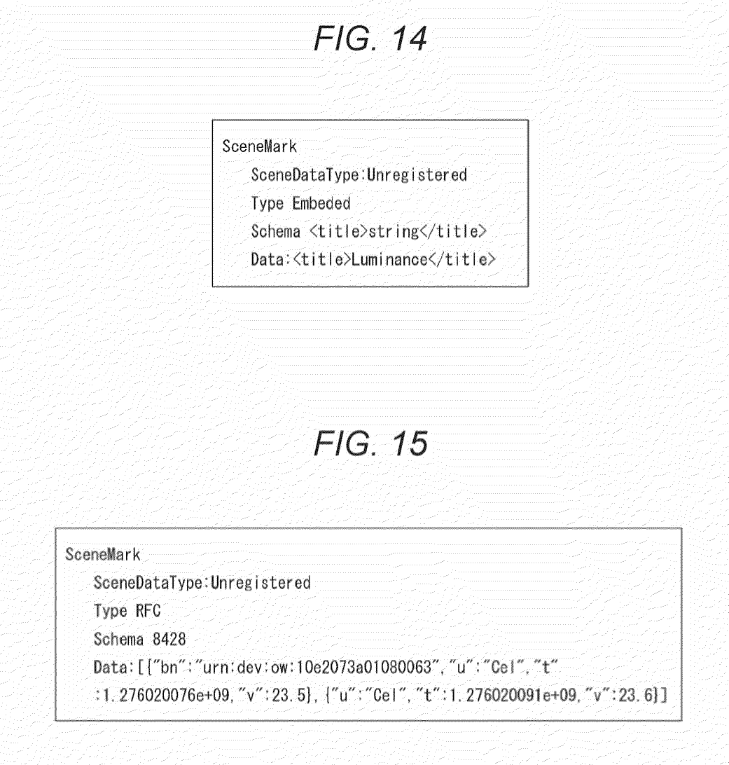

In the above-described examples of FIGS. 12 and 13, Schema is indicated in URI, but as illustrated in FIG. 14, Schema can be directly embedded in “SceneMark”.

In this case, “Embeded” meaning embedding is described in “Type” of “SceneMark”, Schema is directly described in “Schema” as in “<title>string</title>”, and detection result information is described in “Data” as in “<title>Luminance</title>”.

Alternatively, in a case where Schema is defined by an external standard such as Request For Comments (RFC) or Institute of Electrical and Electronics Engineers (IEEE), as illustrated in FIG. 15, information indicating a standard type is described in “Type” of “SceneMark”, and the standard number is described in “Schema”. In the drawing, an application example of RFC 8428 (SenML) is illustrated, and a sensor measurement value is described in a format conforming to RFC 8428 in “Data” in this case.

Here, when it is assumed that Schema is defined in “SceneMark” as in the examples of FIGS. 12 to 15, even when the item of “SceneDataType” is missing by any chance, information of the item of “Data” can be recognized from the information of the items of “Type” and “Schema”.

### 7. Summary of Embodiment

As described above, the data transmission device (sensor device 10) according to the embodiment includes a transmission processing unit (processing unit 12) that performs processing of transmitting sensing data of a detection target in response to occurrence of an event that satisfies a condition specified as an event related to the detection target, in which the sensing data is data including type information indicating the type of sensing data, in a case where whether or not the type of sensing data is a specific type is determined, and as a result, the type of sensing data is an unspecific type, the transmission processing unit performs processing of storing unspecific type information (for example, “Unregisterd”) indicating that the type of sensing data is an unspecific type in the type information (“SceneDataType”) and generating and transmitting the sensing data including text data in which detection result information (“Value”) indicating a detection result of the detection target by text and type information (“Type”) indicating a data type of the detection result information are stored.

According to this, in the device that receives the sensing data, even when the type of sensing data is an unspecific type, it is possible to acquire at least text information indicating the detection result and appropriately present text data indicating the detection result on the basis of the type information.

Therefore, it is possible to only present text information indicating the detection result of the sensor without adding a specification in a new standard for the type of sensor even in a case where a sensor of an unspecific type not specifically assumed in terms of a standard is used in the sensing environment.

Furthermore, in the data transmission device according to the embodiment, the type information is information for identifying the numerical value and the character string.

According to this, in a case where the detection result information is numerical information, it is possible to correctly present the detection result information as the numerical information to the device that receives the sensing data by indicating that the detection result information is numerical information with the type information, and in a case where the detection result information is character string information, it is possible to correctly present the detection result information as the character string information to the device that receives the sensing data by indicating that the detection result information is character string information with the type information.

Therefore, it is possible to allow presentation of at least two types of the numerical information and the character string information as the presentation of the detection result information, and it is possible to improve the degree of freedom of the information type that can be presented as the detection result information.

Moreover, in the data transmission device according to the embodiment, a transmission processing unit performs processing of generating and transmitting text data including unit information (“Unit”) indicating a unit of detection result information as sensing data in a case where the sensing data is of an unspecific type.

According to this, in a case where the detection result information is numerical information, the device that receives the sensing data can present information indicating the unit together with the detection result information with the numerical value.

Therefore, the detection result information can be presented in an easy-to-understand manner.

Moreover, in the data transmission device according to the embodiment, a transmission processing unit performs processing of generating and transmitting text data including information (“Title”) indicating a title of detection result information as sensing data in a case where the sensing data is of an unspecific type.

The information indicating a title of detection result information is information indicating an item name of the detection result information, and can be paraphrased as information indicating an information type of detection result information. With the above-described configuration, the device that receives the sensing data can present title information together with the detection result information.

Therefore, the detection result information can be presented in an easy-to-understand manner.

Furthermore, in the data transmission device according to the embodiment, a transmission processing unit performs processing of generating and transmitting text data including information (“Dimension”) indicating the number of dimensions of detection result information as sensing data in a case where the sensing data is of an unspecific type.

According to this, in a case where the detection result information is information including detection information for each dimension, for example, information including detection information for the vertical direction and information including detection information for the horizontal direction, it is possible to cause the device that receives the sensing data to grasp the number of dimensions of the detection result information, and it is possible to present the detection information for each dimension in a distinguishing manner.

Therefore, it is possible to improve the accuracy of presentation of the detection result information.

Moreover, in the data transmission device according to the embodiment, the sensing data includes an additional data section (“SceneMark”) including type information and an actual data section (“SceneData”) including actual data indicating a detection result, and in a case where the sensing data is of an unspecific type, the transmission processing unit generates an additional data section in which unspecific type information is described as the type information, and generates text data in which the detection result information and the type information are described as the data of the actual data section.

Therefore, in a case where the type of sensing data is an unspecific type, the actual data section indicating the detection result can be made lightweight data by using text data.

Moreover, in the data transmission device according to the embodiment, the transmission processing unit generates the actual data section in a JSON format.

According to this, in a case where the sensing data is of an unspecific type, versatility of the actual data section including the detection result information can be increased.

Therefore, it is possible to enable various devices as devices that receives the sensing data to present detection information of an unspecific sensor.

A data transmission method according to the embodiment is a data transmission method in a data transmission device that performs processing of transmitting sensing data of a detection target in response to occurrence of an event that satisfies a condition specified as an event related to the detection target, in which in a case where the sensing data is data including type information indicating the type of sensing data, whether or not the type of sensing data is a specific type is determined, and as a result, the type of sensing data is an unspecific type, processing of storing unspecific type information indicating that the type of sensing data is an unspecific type in the type information and generating and transmitting the sensing data including text data in which detection result information indicating a detection result of the detection target by text and type information indicating a data type of the detection result information are stored.

Also in the data transmission method according to the embodiment, functions and effects similar to those of the data transmission device according to the above-described embodiment can be obtained.

An information processing device (user device 30) according to the embodiment includes a transmission processing unit that performs processing of transmitting sensing data of a detection target in response to occurrence of an event that satisfies a condition specified as an event related to the detection target, in which the sensing data is data including type information indicating a type of sensing data, and the transmission processing unit includes an acquisition unit (communication unit 60 of the user device 30) that acquires the sensing data transmitted by the data transmission device (sensor device 10) that performs processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type, and a presentation processing unit (CPU 51 of the user device 30) that determines whether or not the type information is unspecific type information on the basis of the sensing data acquired by the acquisition unit and performs presentation processing of the detection result information on the basis of the type information in a case where the type information is the unspecific type information.

According to this, even when the type of sensing data is an unspecific type, text data indicating the detection result can be appropriately presented on the basis of the detection result information and the type information, which are described above.

Therefore, it is possible to only present text information indicating the detection result of the sensor without adding a specification in a new standard for the type of sensor even in a case where a sensor of an unspecific type not specifically assumed in terms of a standard is used in the sensing environment.

An information processing method according to the embodiment is an information processing method in an information processing device including a transmission processing unit that performs processing of transmitting sensing data of a detection target in response to occurrence of an event that satisfies a condition specified as an event related to the detection target, in which the sensing data is data including type information indicating a type of sensing data, and the transmission processing unit acquires the sensing data transmitted by the data transmission device that performs processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type, the information processing method including determining whether or not the type information is unspecific type information on the basis of the acquired sensing data and performing presentation processing of the detection result information on the basis of the type information in a case where the type information is the unspecific type information.

Also in the information processing method according to the embodiment, functions and effects similar to those of the information processing device according to the above-described embodiment can be obtained.

Here, according to the embodiment, it is possible to consider a program for causing, for example, a CPU, a digital signal processor (DSP), or the like, or a device including the CPU and the DSP to execute processing by the processing unit 12 described with reference to FIGS. 4, 9, and the like.

That is, a first program according to the embodiment is a program causing the data transmission device to execute processing, the data transmission device performing processing of transmitting sensing data of a detection target in response to occurrence of an event that satisfies a condition specified as an event related to the detection target, the sensing data being data including type information indicating a type of sensing data, the program causing the data transmission device to execute a function of processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type.

With such a program, the data transmission device according to the embodiment described above can be implemented by the computer device.

Furthermore, according to the embodiment, it is possible to consider the program for causing, for example, a CPU, a DSP, or the like, or a device including the CPU and the DSP to execute processing by the user device 30 described with reference to FIG. 10, and the like.

A second program according to the embodiment is a program causing an information processing device to execute processing, the information processing device including a transmission processing unit that performs processing of transmitting sensing data of a detection target in response to occurrence of an event that satisfies a condition specified as an event related to the detection target, in which the sensing data is data including type information indicating a type of sensing data, and the transmission processing unit acquires the sensing data transmitted by the data transmission device that performs processing of storing unspecific type information indicating that the type of sensing data is an unspecific type in the type information and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type, the program causing the information processing device to execute a function of determining whether or not the type information is unspecific type information on the basis of the acquired sensing data and performing presentation processing of the detection result information on the basis of the type information in a case where the type information is the unspecific type information.

With such a program, the information processing device according to the embodiment described above can be implemented by the computer device.

These programs can be recorded in advance in an HDD and a ROM in a microcomputer having a CPU as a recording medium built in a device of the computer device.

Alternatively, the programs can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, these programs can be installed from the removable recording medium to a personal computer or the like, or can be downloaded from a download site via a network such as a LAN or the Internet.

Furthermore, these programs are suitable for providing the data transmission device and the information processing device of the embodiment in a wide range. For example, by downloading the program to a personal computer, a portable information processing device, a mobile phone, a game device, a video device, a personal digital assistant (PDA), or the like, it is possible to cause the personal computer or the like to function as the data transmission device or the information processing device according to the present technology.

Note that the effects described in the present specification are merely examples and are not limited, and other effects may be provided.

### 8. Present Technology

Note that the present technology can also have the following configurations.

A data transmission device including a transmission processing unit configured to perform processing of transmitting sensing data of a detection target in response to occurrence of an event that satisfies a condition specified as an event related to the detection target,
in which the sensing data is data including type information indicating a type of sensing data, and
in a case where whether or not the type of sensing data is a specific type is determined, and as a result, the type of sensing data is an unspecific type, the transmission processing unit performs processing of storing unspecific type information indicating that the type of sensing data is an unspecific type in the type information, and generating and transmitting the sensing data including text data in which detection result information indicating a detection result of the detection target by text and type information indicating a data type of the detection result information are stored.

The data transmission device according to (1),

in which the type information is information for identifying a numerical value and a character string.

The data transmission device according to (1) or (2),

in which the transmission processing unit performs processing of generating and transmitting text data including unit information indicating a unit of the detection result information as the sensing data in a case where the sensing data is of the unspecific type.

The data transmission device according to any one of (1) to (3),

in which the transmission processing unit performs processing of generating and transmitting text data including information indicating a title of the detection result information as the sensing data in a case where the sensing data is of the unspecific type.

The data transmission device according to any one of (1) to (4),

in which the transmission processing unit performs processing of generating and transmitting text data including information indicating the number of dimensions of the detection result information as the sensing data in a case where the sensing data is of the unspecific type.

The data transmission device according to any one of (1) to (5),
in which the sensing data includes an additional data section including the type information and an actual data section including actual data indicating a detection result, and
in a case where the sensing data is of the unspecific type, the transmission processing unit generates the additional data section in which the unspecific type information is described as the type information, and generates text data in which the detection result information and the type information are described as data of the actual data section.

The data transmission device according to (6),

in which the transmission processing unit generates the actual data section in a JSON format.

A data transmission method in a data transmission device configured to perform processing of transmitting sensing data of a detection target in response to occurrence of an event that satisfies a condition specified as an event related to the detection target,
in which the sensing data is data including type information indicating a type of sensing data, and
in a case where whether or not the type of sensing data is a specific type is determined, and as a result, the type of sensing data is an unspecific type, processing of storing unspecific type information indicating that the type of sensing data is an unspecific type in the type information, and generating and transmitting the sensing data including text data in which detection result information indicating a detection result of the detection target by text and type information indicating a data type of the detection result information are stored is performed.

A program causing a data transmission device to execute processing, the data transmission device performing processing of transmitting sensing data of a detection target in response to occurrence of an event that satisfies a condition specified as an event related to the detection target,
the sensing data being data including type information indicating a type of sensing data,
the program causing the data transmission device to execute a function of processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type.

(10) An information processing device including a transmission processing unit configured to perform processing of transmitting sensing data of a detection target in response to occurrence of an event that satisfies a condition specified as an event related to the detection target, in which the sensing data is data including type information indicating a type of sensing data, and the transmission processing unit includes an acquisition unit configured to acquire the sensing data transmitted by a data transmission device configured to perform processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type, and

a presentation processing unit configured to determine whether or not the type information is the unspecific type information on the basis of the sensing data acquired by the acquisition unit and performs presentation processing of the detection result information on the basis of the type information in a case where the type information is the unspecific type information.

(11) An information processing method in an information processing device including a transmission processing unit configured to perform processing of transmitting sensing data of a detection target in response to occurrence of an event that satisfies a condition specified as an event related to the detection target, in which the sensing data is data including type information indicating a type of sensing data, and the transmission processing unit acquires the sensing data transmitted by a data transmission device configured to perform processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type,

the information processing method including determining whether or not the type information is the unspecific type information on the basis of the acquired sensing data and performing presentation processing of the detection result information on the basis of the type information in a case where the type information is the unspecific type information.

(12) A program causing an information processing device to execute processing, the information processing device including a transmission processing unit configured to perform processing of transmitting sensing data of a detection target in response to occurrence of an event that satisfies a condition specified as an event related to the detection target, in which the sensing data is data including type information indicating a type of sensing data, and the transmission processing unit acquires the sensing data transmitted by a data transmission device configured to perform processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type,

the program causing the information processing device to execute a function of determining whether or not the type information is the unspecific type information on the basis of the acquired sensing data and performing presentation processing of the detection result information on the basis of the type information in a case where the type information is the unspecific type information.

REFERENCE SIGNS LIST

| | |
|---|---|
| 1 | Data distribution system |
| 10 | Sensor device |
| 11 | Sensor unit |
| 12 | Processing unit |
| 13 | Storage unit |
| 14 | Communication unit |
| 20 | Server device |
| 30 | User device |
| 40 | Network |
| 51 | CPU |
| 52 | ROM |
| 53 | RAM |
| 54 | Nonvolatile memory unit |
| 55 | Input and output interface |
| 56 | Input unit |
| 57 | Display unit |
| 58 | Sound output unit |
| 59 | Storage unit |
| 60 | Communication unit |
| 61 | Drive |
| 62 | Removable recording medium |
| 63 | Bus |

1. A data transmission device comprising a transmission processing unit configured to perform processing of transmitting sensing data of a detection target in response to occurrence of an event that satisfies a condition specified as an event related to the detection target,
wherein the sensing data is data including type information indicating a type of sensing data, and
in a case where whether or not the type of sensing data is a specific type is determined, and as a result, the type of sensing data is an unspecific type, the transmission processing unit performs processing of storing unspecific type information indicating that the type of sensing data is an unspecific type in the type information, and generating and transmitting the sensing data including text data in which detection result information indicating a detection result of the detection target by text and type information indicating a data type of the detection result information are stored.

2. The data transmission device according to claim 1,
wherein the type information is information for identifying a numerical value and a character string.

3. The data transmission device according to claim 1,
wherein the transmission processing unit performs processing of generating and transmitting text data including unit information indicating a unit of the detection result information as the sensing data in a case where the sensing data is of the unspecific type.

4. The data transmission device according to claim 1,
wherein the transmission processing unit performs processing of generating and transmitting text data including information indicating a title of the detection result information as the sensing data in a case where the sensing data is of the unspecific type.

5. The data transmission device according to claim 1,
wherein the transmission processing unit performs processing of generating and transmitting text data including information indicating the number of dimensions of the detection result information as the sensing data in a case where the sensing data is of the unspecific type.

6. The data transmission device according to claim 1,
wherein the sensing data includes an additional data section including the type information and an actual data section including actual data indicating a detection result, and
in a case where the sensing data is of the unspecific type, the transmission processing unit generates the additional data section in which the unspecific type information is described as the type information, and generates text data in which the detection result information and the type information are described as data of the actual data section.

7. The data transmission device according to claim 6,
wherein the transmission processing unit generates the actual data section in a JSON format.

8. A data transmission method in a data transmission device configured to perform processing of transmitting sensing data of a detection target in response to occurrence of an event that satisfies a condition specified as an event related to the detection target,
wherein the sensing data is data including type information indicating a type of sensing data, and
in a case where whether or not the type of sensing data is a specific type is determined, and as a result, the type of sensing data is an unspecific type, processing of storing unspecific type information indicating that the type of sensing data is an unspecific type in the type information, and generating and transmitting the sensing data including text data in which detection result information indicating a detection result of the detection target by text and type information indicating a data type of the detection result information are stored is performed.

9. (canceled)

10. An information processing device comprising a transmission processing unit configured to perform processing of transmitting sensing data of a detection target in response to occurrence of an event that satisfies a condition specified as an event related to the detection target, wherein the sensing data is data including type information indicating a type of sensing data, and the transmission processing unit includes an acquisition unit configured to acquire the sensing data transmitted by a data transmission device configured to perform processing of storing unspecific type information indicating that the type of sensing data is an unspecific type in the type information, and generating and transmitting the sensing data including text data in which detection result information indicating a detection result of the detection target by text and type information indicating a data type of the detection result information are stored, in a case where whether or not the type of sensing data is a specific type is determined, and as a result, the type of sensing data is an unspecific type, and
a presentation processing unit configured to determine whether or not the type information is the unspecific type information on a basis of the sensing data acquired by the acquisition unit and performs presentation processing of the detection result information on a basis of the type information in a case where the type information is the unspecific type information.

11. (canceled)

12. (canceled)
